(19) United States
(12) Patent Application Publication
(10) Pub. No.: US 2009/0067885 A1
(43) Pub. Date: Mar. 12, 2009

(54) CONTROLLING APPARATUS FOR CLUTCH

(76) Inventor: Hung-Hsu Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/852,325

(22) Filed: Sep. 10, 2007

(51) Int. Cl. G03G 15/08

(52) U.S. Cl. 399/258

(57) ABSTRACT

A controlling apparatus for controlling at least a clutch includes: a first actuating module; a shaft, coupled to the first actuating module, for driving the first actuating module to rotate; and a controlling circuit, coupled to the shaft, for controlling a rotation of the shaft. When the shaft rotates to a first position, the first actuating module is in contact with the first clutch so as to stop the first clutch from rotating. And when the shaft rotates to a second position, the first actuating module is not in contact with the first clutch, so as to allow the first clutch to rotate.

### BACKGROUND OF THE INVENTION

1. Field of the Invention

The present invention relates to a clutch controlling mechanism, and more particularly, to a clutch controlling apparatus having an actuating module, a shaft and a controlling circuit.

2. Description of the Prior Art

A typical color printer has to control the rotation of developing roller of four color toner cartridges, including a yellow toner cartridge, a cyan toner cartridge, a magenta toner cartridge and a black toner cartridge, to correctly supply toner onto a photoconductor for achieving the objective of color printing.

Please refer to FIG. 1. FIG. 1 is a perspective diagram illustrating a typical rotation controlling apparatus for controlling the rotation of a toner cartridge. The rotation controlling apparatus 100 comprises a spring clutch 110, a blocking lever 120, a spring 130, an electromagnet 140, a first gear 150 and a second gear 160. The spring clutch 110 is coupled to the first gear 150 and the second gear 160, the blocking lever 120 can make contact with a protrusion 112 formed on the spring clutch 110, and the spring 130 is disposed above the electromagnet 140. When the electromagnet 140 is not activated, the blocking lever 120 is pulled by the spring 130, making the front end of the blocking lever 120 come in contact with the protrusion 112 on the spring clutch 110, so the driving power of the first gear 150 cannot be delivered to the second gear 160 via the spring clutch 110. Therefore, the second gear 160 cannot rotate with the first gear 150 and fails to drive a toner cartridge connected to the second gear 160 (not shown in FIG. 1). On the other hand, when the electromagnet 140 is activated, the bottom of the blocking lever 120 is attracted by the electromagnet 140 making the front end of the blocking lever 120 pull away from the protrusion 112, allowing the driving power of the first gear 150 to be delivered to the second gear 160 via the spring clutch 110. Thus, the second gear 160 is allowed to rotate.

As mentioned above, the prior art uses a spring clutch and an electromagnet to control the rotation of the toner cartridge. Since the color printer has to control the rotation of four color toner cartridges, four spring clutches and four electromagnets are required to control the rotation of four color toner cartridges respectively. In this way, the rotation controlling apparatus occupies too much space in a small-size color printer.

### SUMMARY OF THE INVENTION

It is therefore one of the objectives of the present invention to provide a controlling apparatus for controlling at least a clutch and a control mechanism capable of integrating a plurality of clutches in the color printer, to solve the above-mentioned problem.

According to the above-mentioned objective of the present invention, a controlling apparatus is provided. The controlling apparatus comprises an actuating module, a shaft and a controlling circuit. The shaft is coupled to the actuating module and used for driving a rotation of the actuating module. The controlling circuit is coupled to the shaft and used for controlling a rotation of the shaft. When the shaft rotates to a first position, the actuating module will be in contact with a clutch so as to stop the clutch from rotating; and when the shaft rotates to a second position, the actuating module will not be in contact with the clutch so as to allow the clutch to rotate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram illustrating a typical rotation controlling apparatus for controlling the rotation of a toner cartridge.

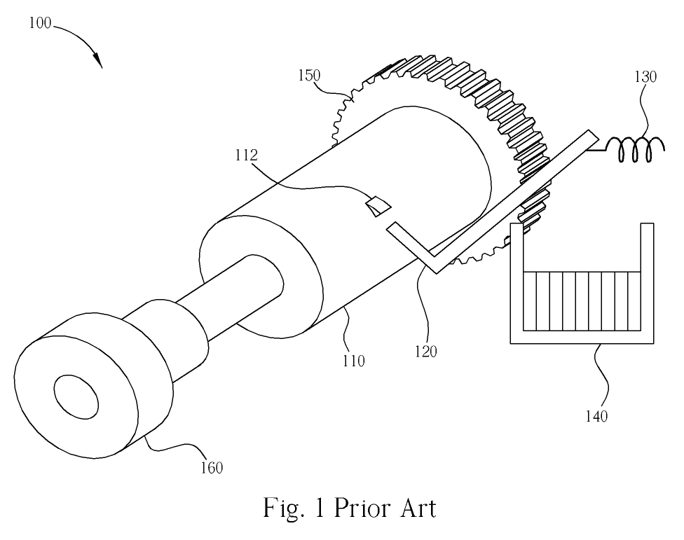

FIG. 2 is a schematic diagram illustrating a clutch controlling apparatus according to a first embodiment of the present invention.

FIG. 3 is a schematic diagram illustrating that the shaft of the clutch controlling apparatus shown in FIG. 2 is located in a first position.

FIG. 4 is a schematic diagram illustrating a first embodiment of a clutch controlling apparatus employing the architecture shown in FIG. 2.

FIG. 5 is a schematic diagram illustrating that the shaft of the clutch controlling apparatus shown in FIG. 4 is in a second position.

FIG. 6 is a schematic diagram illustrating that the shaft of the clutch controlling apparatus shown in FIG. 4 is in a third position.

FIG. 7 is a schematic diagram illustrating a second embodiment of a clutch controlling apparatus employing the architecture shown in FIG. 2.

FIG. 8 is a schematic diagram illustrating a clutch controlling apparatus according to a second embodiment of the present invention.

FIG. 9 is a schematic diagram illustrating that the shaft of the clutch controlling apparatus shown in FIG. 8 is in a second position.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the term “couple” is intended to mean either an indirect or direct electrical connection. Accordingly, if one device is coupled to another device, that connection may be through a direct electrical connection, or through an indirect electrical connection via other devices and connections.

Different features of the present invention are detailed as below in reference to the figures, and for convenience of explanation, the same elements in separate figures are indicated by the same reference numerals.

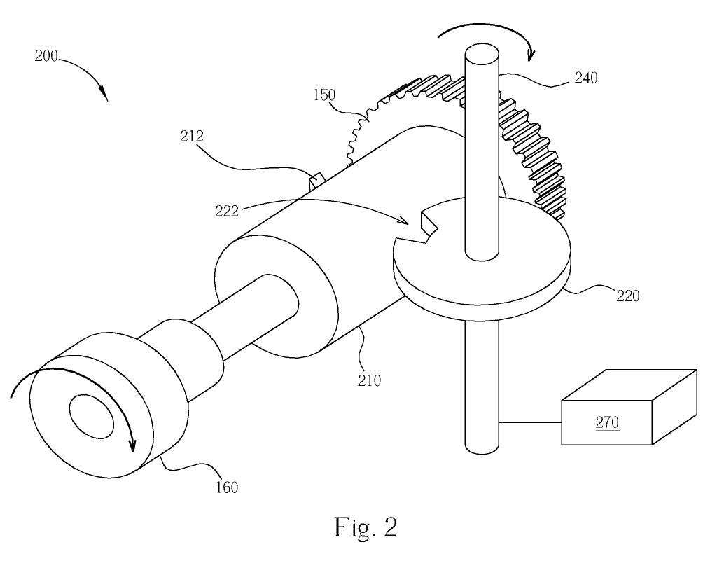

Please refer to FIG. 2. FIG. 2 is a schematic diagram illustrating a clutch controlling apparatus 200 according to a first embodiment of the present invention. The clutch controlling apparatus 200 comprises an actuating module 220, a shaft 240 and a controlling circuit 270. The controlling circuit 270 controls a rotation of the shaft 240 so the actuating module 220, coupled to the shaft 240, rotates with the shaft 240. In this embodiment, when the shaft 240 rotates to a first position, the actuating module 220 will be in contact with a clutch 210 so as to stop the clutch 210 from rotating; and when the shaft 240 rotates to a second position, the actuating module 220 will not be in contact with the clutch 210 so as to allow the clutch 210 to rotate. The operations of the clutch controlling apparatus 200 will be detailed in the following. In this embodiment, a disc actuator is used to implement the actuating module 220. To achieve the same objective of controlling the rotation of the clutch 210, the actuators having other shapes are also workable.

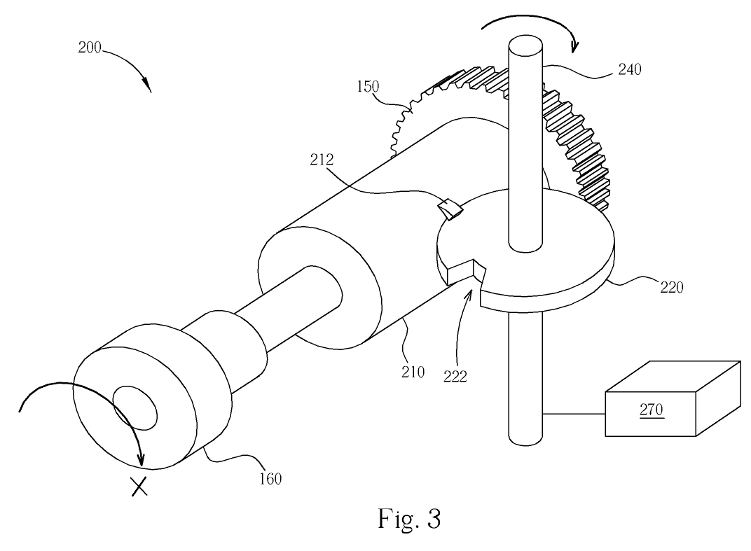

Please refer to FIG. 2, the actuating module 220 has a notch 222, and the clutch 210 has a protrusion 212. When the controlling circuit 270 controls the shaft 240 to rotate to the second position (the position of the shaft 240 in FIG. 2), the notch 222 of the actuating module 220 rotates to a position allowing the protrusion 212 of the clutch 210 to pass through. Thus the clutch 210 can continue rotating to deliver driving power. Please refer to FIG. 3. FIG. 3 is a schematic diagram illustrating that the shaft 240 of the clutch controlling apparatus 200 shown in FIG. 2 is located in the first position. When the controlling circuit 270 controls the shaft 240 to rotate to the first position, the notch 222 of the actuating module 220 is not aligned with protrusion 212 of the clutch 210. Thus the actuating module 220 will block the protrusion 212 of the clutch 210 from rotating, and the clutch 210 cannot continue rotating to deliver driving power thereof.

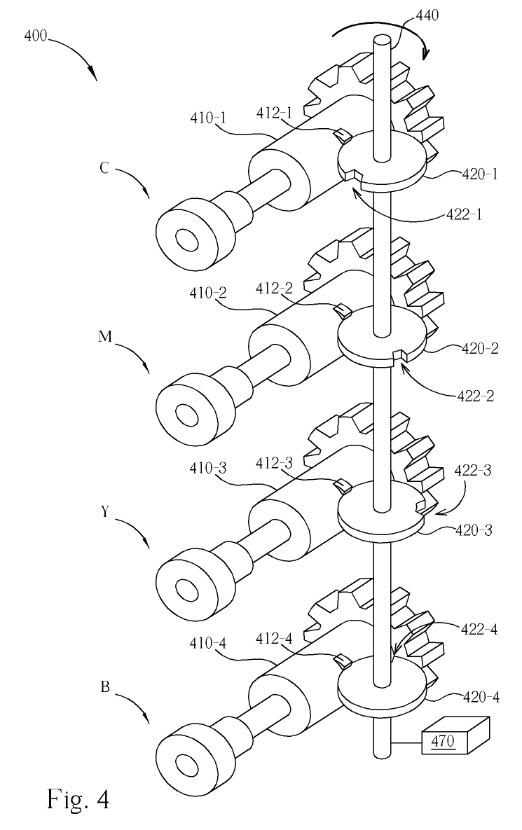

Please refer to FIG. 4. FIG. 4 is a schematic diagram illustrating a first embodiment of a clutch controlling apparatus 400 employing the architecture shown in FIG. 2. In this embodiment, the clutch controlling apparatus 400 is applied to a color printer to control the rotation of four color toner cartridges, including a yellow, a cyan, a magenta, and a black toner cartridge. As shown in FIG. 4, the clutch controlling apparatus 400 comprises a first actuating module 420-1, a second actuating module 420-2, a third actuating module 420-3, a fourth actuating module 420-4, a shaft 440 and a controlling circuit 470. The controlling circuit 470 is used to control the rotation of shaft 440. The actuating modules 420-1-420-4 are all disposed on the shaft 440 and driven by the shaft 440 to rotate. In addition, the actuating modules 420-1-420-4 have a first notch 422-1, a second notch 422-2, a third notch 422-3 and a fourth notch 422-4 to respectively control the rotation of a first clutch 410-1, a second clutch 410-2, a third clutch 410-3 and a fourth clutch 410-4. In this embodiment, the clutches 410-1-410-4 have a first protrusion 412-1, a second protrusion 412-2, a third protrusion 412-3 and a fourth protrusion 412-4, respectively, and these clutches respectively correspond to the four color toner cartridges.

When the color printer is in standby state and has no printing tasks, the controlling circuit 470 will control the shaft 440 to rotate to a first position (the position of the shaft 440 shown in FIG. 4). In this scenario, since the actuating modules 420-1-420-4 block the protrusions 412-1-412-4 of the clutches 410-1-410-4 from rotating, the four color toner cartridges corresponding to the four clutches also cannot rotate; therefore, the toner of all cartridges cannot be transferred onto a photoconductor (not shown).

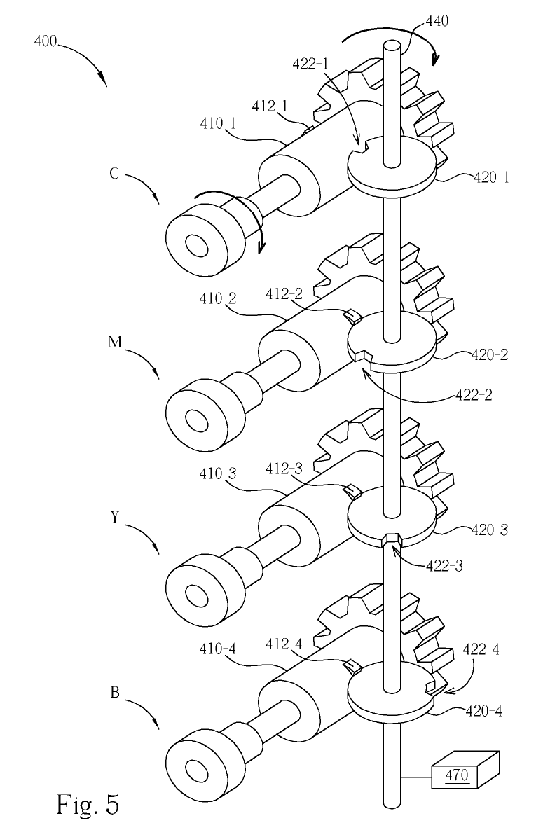

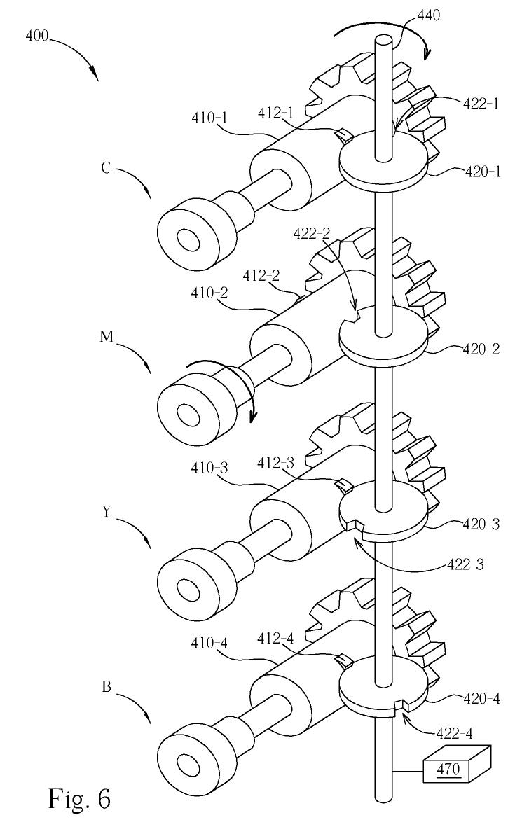

On the other hand, when the color printer starts running printing tasks, the controlling circuit 470 will control the shaft 440 to rotate to a second position. Please refer to FIG. 5. FIG. 5 is a schematic diagram illustrating that the shaft 440 of the clutch controlling apparatus 400 shown in FIG. 4 is in the second position. In this scenario, only the first notch 422-1 of the first actuating module 420-1 rotates to a position allowing the first protrusion 412-1 of the first clutch 410-1 to pass through the first notch 422-1, and the actuating modules 420-2-420-4 block the protrusions 412-2-412-4 of the remaining clutches 410-1-410-4 from rotating. Therefore, only the toner cartridge corresponding to the first clutch 410-1 is allowed to rotate, and thus, only toner in the toner cartridge driven by the first clutch 410-1 can be developed onto the photoconductor. Next, the controlling circuit 470 further controls the shaft 440 to rotate to a third position. Please refer to FIG. 6. FIG. 6 is a schematic diagram illustrating that the shaft 440 of the clutch controlling apparatus 400 shown in FIG. 4 is in the third position. In this scenario, only the second notch 422-2 of the second actuating module 420-2 rotates to a position allowing the second protrusion 412-2 of the second clutch 410-2 to pass through; therefore, only the toner cartridge corresponding to the second clutch 410-2 can rotate, and only toner in it can be transferred onto the photoconductor. The following operation may be deduced by analogy: when the controlling circuit 470 controls the shaft 440 to continue rotating along the direction from the first position to the second position (the direction indicated by the arrow shown in FIG. 4 through FIG. 6), the toner cartridge corresponding to the third clutch 410-3 or the toner cartridge corresponding to the fourth clutch 410-4 can rotate sequentially. Since the detailed operation of the color printer after the toner being transferred onto the photoconductor should be readily appreciated by those skilled in the art, further description is omitted here for the sake of brevity.

In addition, the operation modes of the color printer can generally be divided into color printing mode and monochrome printing mode. The above description is pertinent to the operation of the clutch controlling apparatus 400 when the color printer operates in the color printing mode. When the color printer operates in the monochrome printing mode, only the black toner cartridge need to rotate. Thus, the clutch controlling apparatus 400 only has to control the rotation of the clutch corresponding to the black toner cartridge such as the fourth clutch 410-4. In the above embodiment, when the color printer operates in the color printing mode, the shaft 440 rotates along the direction from the first position to the second position (the direction indicated by the arrow shown in FIG. 4 through FIG. 6). However, when the color printer is in the monochrome printing mode, the controlling circuit 470 will check if the angular displacement of the shaft 440 rotating along a current rotation direction (the direction indicated by the arrow shown in FIG. 4 through FIG. 6) from a current position to a position allowing the black toner cartridge to rotate (i.e. a position allowing the fourth protrusion 412-4 of the fourth clutch 410-4 to pass through the fourth notch 422-1 of the fourth actuating module 420-4) is greater than the angular displacement of the shaft 440 rotating along a rotation direction opposite to the current rotation direction (opposite to the direction indicated by the arrow shown in FIG. 4 through FIG. 6) from the current position to the position allowing the black toner cartridge to rotate. That is, the controlling circuit 470 will check if rotating in the opposite direction will result in a shorter angular distance to desired position. If the check result is logic true, the controlling circuit 470 will control the shaft 440 to rotate along the rotation direction opposite to the current rotation direction (opposite to the direction indicated by the arrow shown in FIG. 4 through FIG. 6) from the current position to the position allowing the black toner cartridge to rotate. In this way, driving power is delivered to the black toner cartridge quickly, and needs not rotate through the unused toner cartridges.

Briefly summarized, with the controlling circuit 470 controlling the shaft 440 through a full rotation, driving power can sequentially be delivered to four color toner cartridges to thereby control the rotation of all color toner cartridges; in other words, utilizing a spring clutch and an electromagnet to control the rotation of the toner cartridges in the prior art can be replaced with using the controlling circuit 470 to control the rotating angle of the shaft 440 to deliver driving power to different color toner cartridges in order to achieve the objective of saving space in the compact color printer. Besides, since the controlling circuit 470 can change the rotation direction of the shaft 440, driving power can be delivered to the black toner cartridge quickly when the color printer operates in the monochrome mode, thereby decreasing the waiting time.

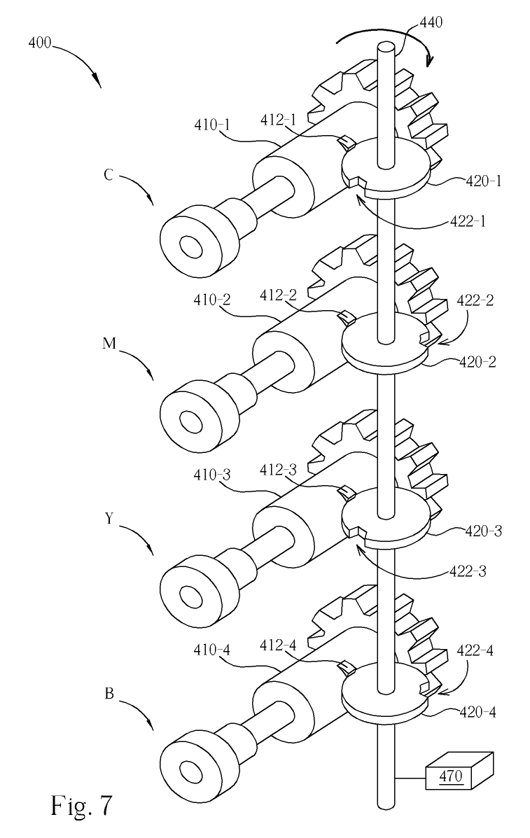

Please note that in the above embodiment the relative positions of the notches 422-1-422-4 of the actuating modules 420-1-420-4 are not aligned vertically, so when the controlling circuit 470 controls the shaft 440 through a full rotation, four color toner cartridges can rotate respectively and sequentially. However, this is merely for illustrative description, and is not a limitation of the present invention. For example, please refer to FIG. 7. FIG. 7 is a schematic diagram illustrating a second embodiment of a clutch controlling apparatus 700 employing the architecture shown in FIG. 2. As shown in FIG. 7, in the actuating modules 420-1-420-4, the positions of the first notch 422-1 and the third notch 422-3 are aligned vertically, and the positions of the second notch 422-2 and the fourth notch 422-4 are aligned vertically. Therefore, when the controlling circuit 470 controls the shaft 440 to have a full rotation, the first and the third toner cartridges rotate simultaneously, and then the second and the fourth toner cartridges rotate simultaneously. Thus, the above embodiment can be utilized in two-pass mode color printer. Similarly, the alignment of the notches is merely for illustrative purposes, and other alternative alignments of the notches also obey the spirit of the present invention.

In addition, in the above embodiment the shaft 440 is a straight shaft; this is merely for illustrative purposes, however, and is not meant to be taken as a limitation of the present invention. In other words, when the placement of the toner cartridges are independent according to the gap between each toner cartridge and the photoconductor, a crooked shaft can be adopted, depending on design requirements. Alternatively, the actuating modules of different size can be adopted for achieving the same objective mentioned above.

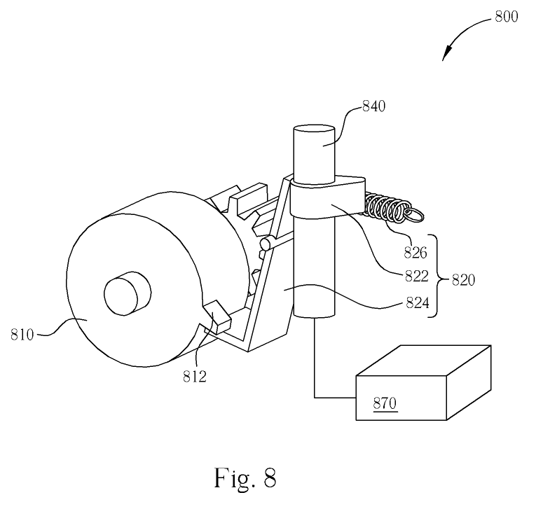

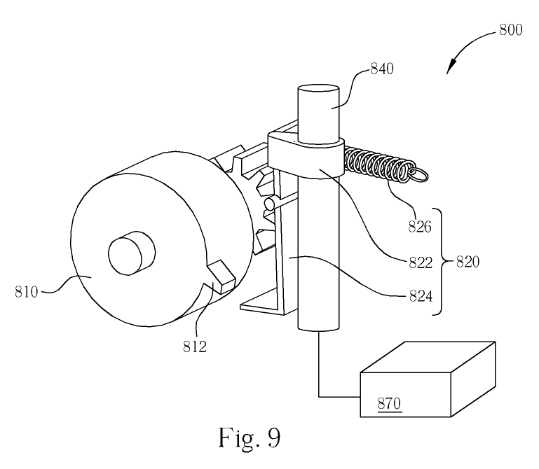

Please refer to FIG. 8. FIG. 8 is a schematic diagram illustrating a clutch controlling apparatus 800 according to a second embodiment of the present invention. As shown in FIG. 8, the clutch controlling apparatus 800 comprises an actuating module 820, a shaft 840 and a controlling circuit 870. The actuating module 820 is coupled to the shaft 840 and rotated due to rotation of the shaft 840 driven by the controlling circuit 870. In this embodiment, the actuating module 820 comprises an actuating unit 822 and a barrier (or blocking lever) 824. In an embodiment, the actuating unit 822 can be but not limit to a cam. In addition, the actuating unit (cam) 822 is disposed on the shaft 840. Thus, when the shaft 840 rotates to a first position (as shown in FIG. 8), the actuating unit (cam) 822 of the actuating module 820 will make the barrier (blocking lever) 824 be located in an initial position and then the barrier 824 will make contact with a protrusion 812 of a clutch 810 to stop the clutch 810 from rotating. Please refer to FIG. 9. FIG. 9 is a schematic diagram illustrating that the shaft 840 of the clutch controlling apparatus 800 shown in FIG. 8 is in a second position. When the shaft 840 rotates to the second position, the convex surface of the actuating unit (cam) 822 of the actuating module 820 will drive the barrier 824 to leave the protrusion 812 of the clutch 810, allowing the clutch 810 to rotate. Furthermore, the actuating module 820 further comprises an elastic unit 826 such as a spring. As shown in FIG. 9, the elastic unit 826 is coupled to the barrier (blocking lever) 824, and when the shaft 840 rotates away from the second position, the elastic unit 826 provides the barrier 824 with an elastic force returning the barrier 824 back to the initial position.

After referring to FIG. 4 through FIG. 9 and related description, a corresponding method for applying the clutch controlling apparatus 800 to a color printer by making color toner cartridges rotate via a shaft should be readily appreciated by those skilled in the art, so further description is omitted here.

Please note that, in the above embodiment, the barrier 824 will be in contact with the protrusion 812 of the clutch 810 to stop the clutch 810 from rotating when the barrier 824 is in the initial position. In other embodiments, a barrier of an actuating module is not in contact with a protrusion of a clutch to allow the clutch to rotate when it is in an initial position through a proper design. In this scenario, when an actuating unit of an actuating module makes contact with a barrier and drives the barrier to leave the initial position, the barrier will make contact with the protrusion of the clutch to stop the clutch from rotating. The same objective of controlling the rotation of the clutches is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controlling apparatus for controlling at least a first clutch, comprising:
a first actuating module;
a shaft, coupled to the first actuating module, for driving the first actuating module to rotate; and
a controlling circuit, coupled to the shaft, for controlling a rotation of the shaft;
wherein when the shaft rotates to a first position, the first actuating module is in contact with the first clutch so as to stop the first clutch from rotating; and when the shaft rotates to a second position, the first actuating module is not in contact with the first clutch, so as to allow the first clutch to rotate.

2. The controlling apparatus of claim 1, wherein the first actuating module has a first notch; the first clutch has a first protrusion; and when the shaft rotates to the second position, the first protrusion of the first clutch is allowed to pass through the first notch.

3. The controlling apparatus of claim 1, wherein the first actuating module comprises a first actuating unit disposed on the shaft, and a first barrier; the first clutch has a first protrusion; when the shaft rotates to the first position, the first barrier is located in an initial position and makes contact with the first protrusion of the first clutch, and when the shaft rotates to the second position, the first actuating module drives the first barrier to leave the initial position and does not make contact with the first protrusion of the first clutch.

4. The controlling apparatus of claim 3, wherein the first actuating module further comprises an elastic unit, coupled to the first barrier, for providing the first barrier with an elastic force to return the first barrier to the initial position when the shaft rotates away from the second position.

5. The controlling apparatus of claim 1, wherein the first actuating module comprises: a first actuating unit, disposed on the shaft, and a first barrier; the first clutch has a first protrusion; when the shaft rotates to the second position, the first barrier is located in an initial position and does not contact with the first protrusion of the first clutch, and when the shaft rotates to the first position, the first actuating module drives the first barrier to leave the initial position and make contact with the first protrusion of the first clutch.

6. The controlling apparatus of claim 5, wherein the first actuating module further comprises an elastic unit, coupled to the first barrier, for providing the first barrier with an elastic force to return the first barrier to the initial position when the shaft rotates away from the first position.

7. The controlling apparatus of claim 5, wherein the first actuating unit is a cam.

8. The controlling apparatus of claim 1, further utilized for controlling a second clutch and comprising a second actuating module, and the shaft further being coupled to the second actuating module, for driving the second actuating module to rotate with the rotation of the shaft, wherein when the shaft rotates to the first position, the second actuating module does not make contact with the second clutch, so as to allow the second clutch to rotate.

9. The controlling apparatus of claim 8, wherein the second actuating module has a second notch; the second clutch has a second protrusion; and when the shaft rotates to the first position, the second protrusion of the second clutch is allowed to pass through the second notch.

10. The controlling apparatus of claim 8, wherein the shaft is a crooked shaft.

11. The controlling apparatus of claim 8, wherein a size of the second actuating module differs from a size of the first actuating module.

12. The controlling apparatus of claim 1, further utilized for controlling a second clutch and comprising a second actuating module, and the shaft further being coupled to the second actuating module, for driving the second actuating module to rotate with the rotation of the shaft, wherein when the shaft rotates to the first position, the second actuating module is in contact with the second clutch so as to stop the second clutch from rotating.

13. The controlling apparatus of claim 12, wherein the second actuating module comprises a second actuating unit disposed on the shaft, a second barrier, and the second clutch has a second protrusion; when the shaft rotates to the first position, the second barrier is located in a second initial position and makes contact with the second protrusion of the second clutch.

14. The controlling apparatus of claim 13, wherein the second actuating module further comprises a second elastic unit, coupled to the second barrier, for providing the second barrier with an elastic force to return the second barrier to the second initial position.

15. The controlling apparatus of claim 1, further utilized for controlling a second clutch and comprising a second actuating module, and the shaft further being coupled to the second actuating module, for driving the second actuating module to rotate with the rotation of the shaft, wherein when the shaft rotates to the second position, the second actuating module does not make contact with the second clutch, so as to allow the second clutch to rotate.

16. The controlling apparatus of claim 15, wherein the second actuating module has a second notch; the second clutch has a second protrusion; and when the shaft rotates to the second position, the second protrusion of the second clutch is allowed to pass through the second notch.

17. The controlling apparatus of claim 15, wherein the second actuating module comprises a second actuating unit disposed in the shaft, and a second barrier; the second clutch has a second protrusion; when the second barrier is located in a second initial position, the second barrier makes contact with the second protrusion of the second clutch, and when the shaft rotates to the second position, the second actuating module drives the second barrier to leave the second initial position and not contact with the second protrusion of the second clutch.

18. The controlling apparatus of claim 17, wherein the second actuating module further comprises a second elastic unit, coupled to the second barrier, for providing the second barrier with an elastic force to return the second barrier back to the second initial position.

19. The controlling apparatus of claim 1, wherein when the shaft rotates along a first rotation direction and the controlling circuit detects that an angular displacement of the shaft rotating along the first rotation direction from a current position to the second position is greater than an angular displacement of the shaft rotating along a second rotation direction, opposite to the first rotation direction, from the current position to the second position, the controlling circuit controls the shaft to rotate along the second rotation direction from the current position to the second position.

20. An image forming apparatus including a controlling apparatus according to claim 1, wherein a toner cartridge of the image forming apparatus develops toner to a photoconductor by controlling the rotation of the first clutch.
